(19) United States
(12) Patent Application Publication
(10) Pub. No.: US 2025/0281844 A1
(43) Pub. Date: Sep. 11, 2025

(54) MOTION SIMULATION SYSTEM WITH ROLLING BEARINGS

(71) Applicant: ARkinematics LTD, Nicosia (CY)

(72) Inventors: Louis HajiChristou, Nicosia (CY); Michael A. Gregoriades, Nicosia (CY)

(21) Appl. No.: 19/071,622

(22) Filed: Mar. 5, 2025

Related U.S. Application Data
(60) Provisional application No. 63/563,937, filed on Mar. 11, 2024.

(51) Int. Cl. A63G 31/14; B25J 9/00

(52) U.S. Cl. CPC A63G 31/14; B25J 9/003

(57) ABSTRACT

The various embodiments described herein include methods, devices, and systems for simulating motion. In one aspect, a movable platform system includes a base, a platform, and a plurality of links coupling the base to the platform. The plurality of links are configured to permit the platform to move in six degrees of freedom relative to the base. The plurality of links includes at least four links. The second link is coupled to the first link via a first rotational joint. A fourth link is s coupled to the third link via a second rotational joint and coupled to the platform via a prismatic joint.

### RELATED APPLICATIONS

This application claims the benefit of priority U.S. Provisional Patent Application Ser. No. 63/563,937 entitled “MOTION SIMULATION SYSTEM WITH ROLLING BEARINGS” filed on Mar. 11, 2024, the disclosure of which is hereby incorporated by reference in its entirety for all purposes.

### TECHNICAL FIELD

The present disclosure relates generally to parallel robots, including, but not limited to motion simulation systems.

### BACKGROUND

Motion simulation systems have included platforms for supporting and initiating physical movement for participants in amusement attractions and simulation products, e.g., video gaming. Such systems have been designed to provide physical movement to participants in film or computer simulation/gaming activities. The Stewart platform (or hexapod) is a well-known form of simulator which moves a platform relative to a base in all six degrees of freedom.

In some applications, hexapods include six linear actuators arranged to move the platform in six degrees of freedom, particularly three linear and three rotational degrees of freedom, relative to the base, depending on which actuators are used in combination. The translational degrees of freedom are commonly known as surge (horizontal movement in the direction of travel), sway (horizontal movement perpendicular to the direction of travel), and heave (vertical motion). The rotational degrees of freedom are known as roll (rotation about an axis parallel to the direction of travel), pitch (rotation about a horizontal axis perpendicular to the direction of travel), and yaw (rotation about a vertical axis).

In certain applications, the connecting rod and/or actuators of the hexapod can include plain bearings, such as ball joints, that allow for pivot or rotation of the connecting elements relative to a base and/or platform of the hexapod. In some applications, certain ball joints may have a limited swivel angle, potentially limiting the motion of the connecting elements, which may result in limiting the motion envelope of the hexapod. Further, ball joints may limit dynamic system performance and may get damaged if moved outside their motion envelope.

### SUMMARY

Accordingly, there is a need for a motion simulation system capable of providing a desired range of motion while providing increased durability, reduced friction, and dynamic performance.

The present disclosure describes parallel robots, including, but not limited to, movable platform systems and motion simulation systems to initiate physical movement for amusement and simulation purposes. In some applications, parallel robots can be used for various applications, such as stabilizing a patient's bed in an ambulance or other vehicle to prevent the patient from experiencing unwanted shocks and/or vibration during travel. In some embodiments, the parallel robot includes one or more links to allow the platform to move in six degrees in freedom relative to the base.

The movable platform system can include a plurality of links. The links can be coupled to the base or the platform and can be coupled to each other via rotational joints. Some of the links can be coupled to the platform via a prismatic joint. Some of the links, such as the first and second links can move or rotate in parallel or coinciding planes. Other links, such as the third link, can rotate in a plane that is different or perpendicular to the parallel or coinciding planes of movement of the first and second links. The fourth link can rotate in a different or perpendicular plane to the third link. In some embodiments, the rotational joints of the movable platform system utilize rolling bearings.

The movable platform system can include positioning actuators. The positioning actuators can include a stator coupled to the base and a rotor coupled to a link. The rotor of the positioning actuator and the link can rotate in parallel or coinciding planes. A second link attached thereto can rotate in a perpendicular plane. In some embodiments, the positioning actuators can be rotational actuators or linear actuators.

The movable platform system can include multiple sets of links. In some embodiments, the movable platform system can include three sets of links to support and permit movement of the platform.

The movable platform system can include links that are weight bearing links. The weight bearing links can move in a parallel plane or two coinciding planes as the first and second links. The weight bearing link can include a weight bearing actuator. The weight bearing actuator can include a pneumatic cylinder and a piston rod. The cavity within the pneumatic cylinder can be pressurized to support the weight of the platform. The movable platform system can include multiple weight bearing actuators.

The movable platform system can include a controller to control operation of the actuators.

As discussed previously, certain conventional motion simulation systems can have a limited range of motion, limited dynamic system performance, and may have components that can be damaged. The present disclosure includes embodiments that allow for a desired motion envelope and improved durability. Embodiments of the present disclosure can utilize rolling bearings and reduce or eliminate the use of plain spherical bearings.

In one aspect, some embodiments include a moveable platform system including a base; a platform; and a plurality of links coupling the base to the platform and configured to permit the platform to move in six degrees of freedom relative to the base, wherein the plurality of links includes: a first link coupled to the base via a first rotational joint; a second link coupled to the first link via a second rotational joint; a third link coupled to the second link via a third rotational joint; a fourth link coupled to the third link via a fourth rotational joint and a fifth link, wherein the fifth link is coupled to the fourth link via a fifth rotational joint and coupled to the platform via a prismatic joint.

In another aspect, some embodiments include a motion simulation system including a base; a platform; six positioning actuators coupled to the base, wherein the positioning actuators are configured to position the platform relative to the base; and a plurality of links coupling the base to the platform and configured to permit the platform to move in six degrees of freedom relative to the base, wherein the plurality of links includes: a first link coupled to the base via a first rotational joint; a positioning actuator actuating this first rotational joint, a second link coupled to the first link via a second rotational joints; a third link coupled to the second link via a third rotational joint, a fourth link coupled to the third link via a fourth rotational joint and a fifth link, wherein the fifth link is coupled to the fourth link via a fifth rotational joint and coupled to the platform via a prismatic joint.

In another aspect, some embodiments include a motion simulation system including a base; a platform; a weight bearing actuator coupled to the base and the platform, wherein the weight bearing actuator is configured to support the platform relative to the base; and a plurality of links coupling the base to the platform and configured to permit the platform to move in six degrees of freedom relative to the base, wherein the plurality of links including: a first link coupled to the base via a first rotational joint; and a second link coupled to the first link via a second rotational joint, wherein the weight bearing actuator, first link and the second link move in planar motions on parallel or coinciding planes.

Thus, systems and methods are provided for simulating motion with a desired motion envelope and more durable components, thereby increasing the performance and durability of such systems and devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a perspective view of a motion simulation system in accordance with some embodiments.

FIG. 2 is a perspective view of a motion simulation system in accordance with some embodiments.

FIG. 3 is a side elevation view of the motion simulation system of FIG. 2.

FIG. 4 is a perspective view of a motion simulation system in accordance with some embodiments.

FIG. 5 is a perspective view of a motion simulation system in accordance with some embodiments.

### DETAILED DESCRIPTION

The present disclosure describes various embodiments of motion simulation systems. In some embodiments, a motion simulation system includes rolling bearings to allow for a desired range of motion while increasing durability over certain conventional motion simulation systems.

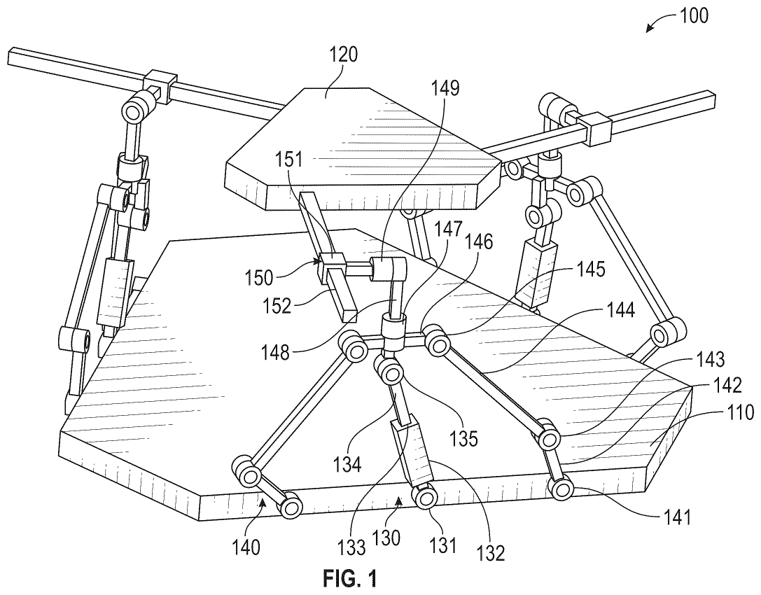

FIG. 1 is a simplified perspective view of a parallel robot or motion simulation system 100 in accordance with some embodiments. With reference to FIG. 1, the motion simulation system 100 can support, stabilize, and/or position a payload disposed on a platform 120 relative to a base 110 to position, stabilize, or provide motion information, signals, or other feedback to a user. In some embodiments, the payload can include, but is not limited to, a user, a seat, a bed, and/or hardware. In some embodiments, the hardware can include, but is not limited to automotive simulation hardware (e.g. a steering wheel and pedals), aviation simulation hardware, or other suitable hardware.

As illustrated, a platform 120 can support and position the payload relative to the base 110. In the depicted example, the base 110 can support weight of the platform 120 and the payload, as well as the other components of the motion simulation system 100.

As described herein, one or more weight bearing links 130 can support the weight of the platform 120 and the payload relative to the base 110. Further, one or more positioning links 140 can move or position the platform 120 and the payload relative to the base 110.

In the depicted example, a weight bearing link 130 can support the platform 120 and the payload at a desired pose relative to the base 110. In the depicted example, the weight bearing links 130 support the platform 120 and the payload without affecting a position of the platform 120 during normal operation. Advantageously, the use of weight bearing links 130 can reduce the load imparted on the positioning links 140.

In the depicted example, the weight bearing link 130 is coupled to the platform 120 and the base 110. As illustrated, one end 131 of the weight bearing link 130 can be coupled to the base 110 and an opposing end 135 of the weight bearing link 130 can be coupled to the platform 120. In some embodiments, an end 135 can be coupled directly to the platform 120 or to one or more positioning links 140. In some embodiments, the placement of the joints, connections, or ends 131, 135 of the weight bearing links 130 relative to the platform 120 and/or base 110 may be co-planar, symmetric, non-symmetric, or may otherwise vary. In some embodiments, the ends 131, 135 of the weight bearing link 130 can be pivotably coupled to the base 110 and the platform 120.

In the depicted example, the ends 131, 135 of the weight bearing link 130 can be rotational joints that rotate in parallel or coinciding planes, allowing each respective weight bearing link 130 to move in a generally planar motion. In some embodiments, the ends 131, 135 can include rolling bearings. The rolling bearings may be ball bearings, cylindrical roller bearings, spherical roller bearings, tapered roller bearings, and/or needle roller bearings.

Prior to normal operation of the motion simulator system 100, the weight bearing links 130 can be extended to a desired length to serve as a leg or otherwise support the platform 120 and the payload at a desired pose. In the depicted example, the weight bearing link 130 includes a sliding joint 133 that allows one link portion 134 coupled to the end 135 to extend relative to another link portion 132 coupled to the end 131. In some embodiments, the sliding joint 133 can be a prismatic joint, a cylindrical joint, or any other suitable type of joint. In some embodiments, the weight bearing link 130 is a pneumatic cylinder that utilizes the link portion 134 as a piston rod that is movable relative to the link portion 132 which is utilized as a pneumatic cylinder. Embodiments of the weight bearing link are described in U.S. application Ser. No. 18/106,961, filed Feb. 7, 2023 by Louis HajiChristou et al., incorporated by reference herein.

In the depicted example, each positioning link (collectively identified as positioning links 140) can move or position the platform 120 and the payload to a desired pose relative to the base 110. In the depicted example, the positioning links 140 can collectively or cooperatively position the platform 120 in any six-dimensional pose relating to surge, sway, heave, yaw, pitch, and roll within the motion space envelope of the motion simulation system 100.

In the depicted example, the positioning links 140 are coupled to the platform 120 and the base 110. As illustrated, the positioning links 140 can be coupled to each other or to the base 110 and platform 120. As described herein, the motion simulation system 100 can include one or more positioning links 140 connected or coupled together via joints and links to allow for movement of the platform 120 relative to the base. In some embodiments, the positioning links 140 can be pivotably coupled or slidingly coupled to each other, to the base 110, and/or to the platform 120. The positioning links 140 can be arranged in one or more sets or groups. In some embodiments, certain positioning links 140 can be coupled to the weight bearing link 130. In some embodiments, the placement of the joints or positioning links 140 relative to the platform 120 may be co-planar, non-coplanar, symmetric, non-symmetric, or may otherwise vary.

As illustrated, a first group of the positioning links 140 can move in parallel or coinciding planes. For example, a first positioning link 142 can be coupled to the base 110 via a joint 141. The opposite end of the first positioning link 142 can be coupled to a second positioning link 144 via a joint 143. The second positioning link 144 can be coupled to a common positioning link 146 via a joint 145. As illustrated, second set of positioning links 140 and joints can couple the common positioning link 146 to the base 110. The second set of positioning links 140 can have a symmetrical or otherwise similar arrangement as the first positioning link 142 and the second positioning link 144.

In the depicted example, the joints 141, 143, 145 can be rotational joints with parallel axes of rotation, allowing the positioning links 142, 144, 146 to move in a parallel or coinciding planes. In the depicted example, the rotational joints 141, 143, 145 kinematically constrain the positioning links 142, 144, 146 to move in parallel planar motion paths. In some embodiments, the weight bearing link 130 can be coupled to the common positioning link 146 to move in a parallel planar motion path as the positioning links 142, 144, 146. As described herein, the weight bearing link 130 can include a rotational joint at the end 135 coupled to the common positioning link 146.

In some embodiments, a positioning link 148 can move or rotate in a different or perpendicular plane than the first group of link elements. The positioning link 148 can be coupled to the common positioning link 146 via a joint 147. The positioning link 148 can be coupled to the common positioning link 146 at a midpoint or otherwise away from the ends of the common positioning link 146. The opposite end of the positioning link 148 can be coupled to a sliding assembly 150 via a joint 149. In the depicted example, the joint 147 can be a rotational joint that rotates in a different or perpendicular plane or axis to the first group of joints 141, 143, 145, allowing the positioning link 148 to rotate in a perpendicular plane or axis to the parallel planes of positioning links 142, 144, 146. As illustrated, the positioning link 148 can rotate perpendicular to the parallel planes of positioning links 142, 144, 146.

Further, in some embodiments, the sliding assembly 150 can move in a different or perpendicular plane to the positioning link 148 and/or the first group of positioning links 140. As described above, sliding assembly 150 can be coupled to the positioning link 148 via the joint 149. In the depicted example, the joint 149 can be a rotational joint that rotates in a different or perpendicular plane or axis to joint 147 and/or the first group of joints 141, 143, 145, allowing the sliding assembly 150 to rotate in a different or perpendicular plane or axis to the plane of the positioning link 148 and/or the parallel or coinciding planes of positioning links 142, 144, 146. As illustrated, the sliding assembly 150 can rotate perpendicular to the axis of rotation of the joint 147.

In some embodiments, one or more of the rotational joints 141, 143, 145,147, 149 can include rolling bearings. The rolling bearings can be ball bearings, cylindrical roller bearings, spherical roller bearings, tapered roller bearings, and/or needle roller bearings.

In the depicted example, the sliding assembly 150 can allow the platform 120 to slide or translate relative to the other positioning links 140. As illustrated, a sliding positioning link 152 is coupled to the platform 120. In some embodiments, the sliding assembly 150 includes a sliding joint 151 that allows the sliding positioning link 152 slide, translate, or otherwise move relative to the joint 149 and other positioning links 140, permitting the platform 120 to slide, translate, or otherwise move relative to the joint 149 and other positioning links 140. In some embodiments, the sliding joint 151 can be a prismatic joint, or any other suitable type of joint. Optionally, the sliding joint 151 can include two parallel cylindrical joints to allow for translation while constraining rotational motion.

As described herein, the movement and arrangement of the sliding positioning links 140 can collectively or cooperatively position the platform 120 in any six-dimensional pose relating to surge, sway, heave, yaw, pitch, and roll within the motion space envelope of the motion simulation system 100. In some embodiments, one or more positioning links 140 can be used with or include an actuator to move, adjust or otherwise position the positioning links 140 and in turn the platform 120. In the depicted example, the motion simulation system 100 includes six positioning links 140. During operation of the motion simulation system, one or more actuators can move a respective positioning link 140 to position the platform 120 in a desired position. Embodiments of positioning actuators are described in U.S. application Ser. No. 18/106,961, filed Feb. 7, 2023 by Louis HajiChristou et al., incorporated by reference herein.

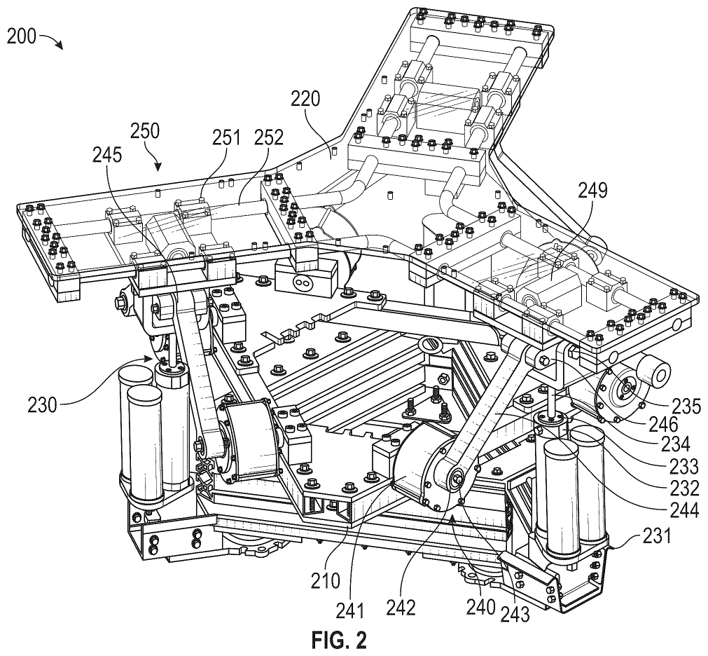

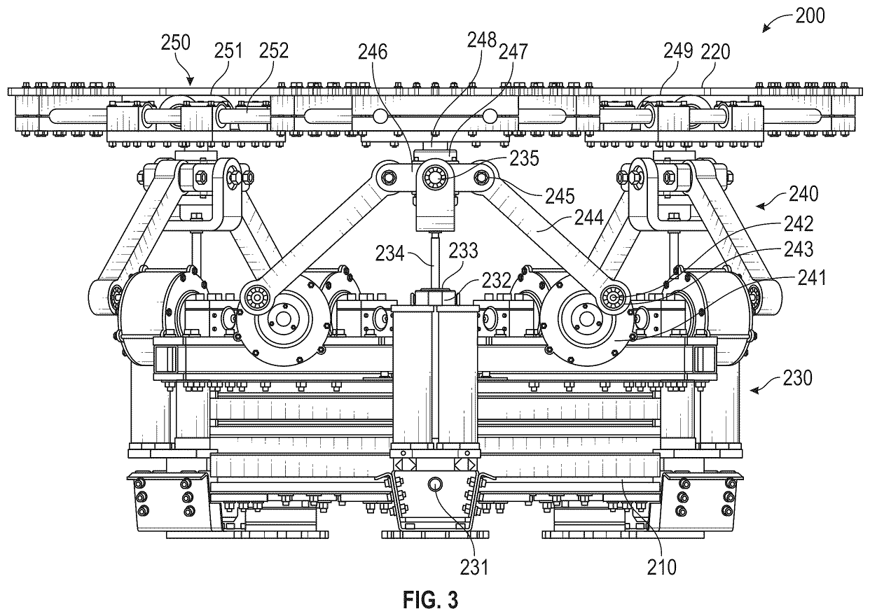

FIG. 2 is a perspective view of a motion simulation system 200 in accordance with some embodiments. FIG. 3 is a side elevation view of the motion simulation system 200 of FIG. 2. With reference to FIGS. 2 and 3, in some embodiments, the motion simulation system 200 can include features that are similar to the features that are schematically depicted with respect to motion simulation system 100 and can further include one or more weight bearing actuators 230 and/or positioning actuator assemblies 240. Features of motion simulation 200 that are similar to the features of motion simulation system 100 are referred to with similar reference numerals. As described herein, the motion simulation system 200 can include weight support features and positioning features that are similar to the features of motion simulation system 100.

As described herein, one or more weight bearing actuators 230 can support the weight of the platform 220 and the payload relative to the base 210. In the depicted example, the weight bearing actuator 230 is coupled to the platform 220 and the base 210 in a similar manner as described above with respect to weight bearing link 130. As illustrated, one end 231 of the weight bearing actuator 230 can be coupled to the base 210 and an opposing end 235 of the weight bearing actuator 230 can be coupled to the platform 220 In some embodiments, an end 235 can be coupled directly to the platform 220. In some embodiments, the placement of the joints, connections, or ends 231, 235 of the weight bearing actuators 230 relative to the platform 220 and/or base 210 may be co-planar, non-coplanar, symmetric, non-symmetric, or may otherwise vary. In some embodiments, the ends 231, 235 can be pivotably coupled to the base 210 and the platform 220. In the depicted example, the opposing end 235 of the weight bearing actuator 230 can be coupled to the link 246.

As described above, the weight bearing actuators 230 can be coupled to the base 210, the platform 220, and/or link 246 via rotational joints, allowing each respective weight bearing actuator 230 to move in a planar motion. In some embodiments, the ends 231, 235 can include rolling bearings. The rolling bearings may be ball bearings, cylindrical roller bearings, spherical roller bearings, tapered roller bearings, and/or needle roller bearings.

Prior to normal operation of the motion simulator system 200, the weight bearing actuators 230 can be extended to a desired length to serve as a leg or otherwise support the platform 220 and the payload at a desired pose. In the depicted example, the weight bearing actuator 230 is a pneumatic actuator that utilizes air pressure to extend and support the platform 220 and the payload at the desired pose. In some embodiments, the pneumatic actuator includes a piston rod 234 that is movable relative to a pneumatic cylinder 232 to define a cylindrical joint 233.

As illustrated, a first end of a piston rod 234 is at least partially disposed within a cavity of a pneumatic cylinder 232 to define a cylinder volume. During operation, the cylinder volume can be pressurized to advance the piston rod 234 and support the platform 220. As described herein, the pressure of the cylinder volume can be adjusted to adjust the position of the piston rod 234 relative to the pneumatic cylinder 232 and support various payload weights, platform heights and/or poses. As described herein, the opposite end 235 of the piston rod 234 is coupled to the platform 220. In the depicted example, the opposite end of the piston rod 234 is coupled to the link 246.

In some embodiments, the pneumatic cylinder 232 can be pressurized by a pneumatic control circuit. The pneumatic control circuit can include a compressor to pressurize the cylinder volume to a desired pressure. The pneumatic control circuit can introduce, relieve, or otherwise control pressure within the cylinder volume.

In some embodiments, the weight bearing actuator 230 can provide a relatively large non-variable or dead volume in comparison to the variable swept volume of the pneumatic cylinder 232 and piston rod 234 to minimize variations in pressure and therefore actuation force as the piston rod 234 moves through its stroke. In the depicted example, the weight bearing actuator 230 includes one or more buffer tanks in fluid communication with the pneumatic cylinder 232 to provide additional dead volume to the pneumatic cylinder 232. As illustrated, the weight bearing actuator 230 can include two buffer tanks. Advantageously, since the volume of the buffer tanks is comparatively large with respect to the volume of the cylinder, overall variations in pressure in the weight bearing actuator 230 (i.e. volume of the buffer tanks and the cylinder volume combined) as the cylinder volume changes are minimized, similarly minimizing changes in force provided by the weight bearing actuator 230.

In some embodiments, one or more positioning links can be actuated by a positioning actuator assembly 240. As illustrated, the positioning actuator assembly 240 can move or position a connecting rod or link element 244, which can in turn cooperatively position the platform 220 in a desired position. In the depicted example, the positioning actuator assembly 240 rotates rotor 242 to adjust the position of the link element 244. In some embodiments, the rotor 242 can be rotatably coupled to the link element 244 via a rotational joint 243. In some embodiments, the rotational joint 243 can include rolling bearings. The rolling bearings can be ball bearings, cylindrical roller bearings, spherical roller bearings, tapered roller bearings, and/or needle roller bearings.

As described herein, one or more of the positioning links 244 can be moved or otherwise actuated by a positioning actuator or actuated joint or 241 to move the platform 220 to a desired position or pose. In the depicted example, the positioning actuator 241 can be coupled to the base 210 and a positioning link 244 to actuate the positioning link 244 and in turn, other positioning links 244 and the platform 220. In some embodiments, the positioning actuator or actuated joint 241 can rotate a rotor 242 to move or actuate the positioning link 244. As illustrated, the positioning link 244 can be coupled to the rotor 242 via joint 243. In the depicted example, the joint 243 is a rotational joint that can rotate in a parallel plane with the rotor 242 and the common positioning link 246. The rotational joint 243 can kinematically constrain the positioning link 244. In some embodiments, the joint 243 can include rolling bearings. Similar to embodiments of motion simulation system 100, the opposite end of the positioning link 244 can be coupled to the common positioning link 246 with a joint 245. In the depicted example, the joint 245 is a rotational joint that can rotate in a parallel plane with the common positioning link 246. In some embodiments, the joint 245 can include rolling bearings. The rolling bearings can be ball bearings, cylindrical roller bearings, spherical roller bearings, tapered roller bearings, and/or needle roller bearings.

Optionally, the rotor 242 can have a linkage, such as a crank coupled to rotate with the rotor 242 to move or translate the positioning link 244. In some embodiments, the length or geometry of the rotor 242 and other components of the positioning actuator 241 can be altered to adjust the relationship between the rotation of the rotor 242 and the movement of the positioning link 244. Further, in some embodiments, the positioning actuator assembly 240 can be substituted with a linear actuator.

Advantageously, the direct attachment or connection between the positioning link 244, and the rotor 242 of the positioning actuator 241 allows for a direct-drive mechanism or arrangement, adjust the position of the platform 220. Further, the absence of intervening or intermediate machine or power transmission elements allows for direct and immediate transfer of the weight and inertia loads of the platform 220 and payload to the positioning actuator 241 and allows for increased system stiffness and response, permitting the motion simulation system 200 to reject or overcome static external disturbances (e.g. when an axis is holding a position or speed) and dynamic external disturbances (e.g. when an axis is following a position or speed trajectory).

In some embodiments, the positioning actuator 241 rotates the rotor 242 relative to a stator disposed within the housing of the positioning actuator 241. In some embodiments, the positioning actuator 241 includes a rotary encoder to determine the rotational position of the rotor 242 relative to the stator or other stationary portions of the positioning actuator 241. Signals from rotary encoder can be used as feedback for closed loop control of the positioning actuator assembly 240 and the motion control system 200, generally. In some embodiments, a linear encoder can determine the linear position of a linear actuator to similarly provide feedback for closed loop control.

In some embodiments, other elements, such as positioning links 244 of motion simulation system 200 may be similar to the elements schematically depicted with respect to the motion simulation system 100. In some embodiments, the motion simulation system 200 can include multiple sliding assemblies 250 to allow the platform 220 to slide or translate relative to other positioning links 244 or relative to base 210. As illustrated, the motion simulation system 200 can include multiple sliding positioning links or rails 252 coupled to the platform 220. In the depicted example, the sliding positioning rails 252 are rigidly coupled to the platform 220. In some embodiments, the motion simulation system 200 includes corresponding sliding joints 251 that allows the sliding positioning links or rails 252 to slide, translate, or otherwise move relative to the link 250 and other positioning links 244, permitting the platform 220 to similarly slide, translate, or otherwise move relative to the link 250 and other positioning links 244. In some embodiments, the sliding joints 251 can be prismatic joints, cylindrical joints, or any other suitable type of joints. In some embodiments, one or more sliding assemblies 250 can be coupled to the common positioning link 246 with an intermediate link 248. In the depicted example, the intermediate link 248 can be coupled to the common positioning link 246 via a rotational joint 247. In some embodiments, the joint 247 can include rolling bearings. In some embodiments, the opposite end of the intermediate link 248 can be coupled to the sliding assembly 250 via a rotational joint 249. Similarly, the joint 248 can include rolling bearings. The rolling bearings can be ball bearings, cylindrical roller bearings, spherical roller bearings, tapered roller bearings, and/or needle roller bearings.

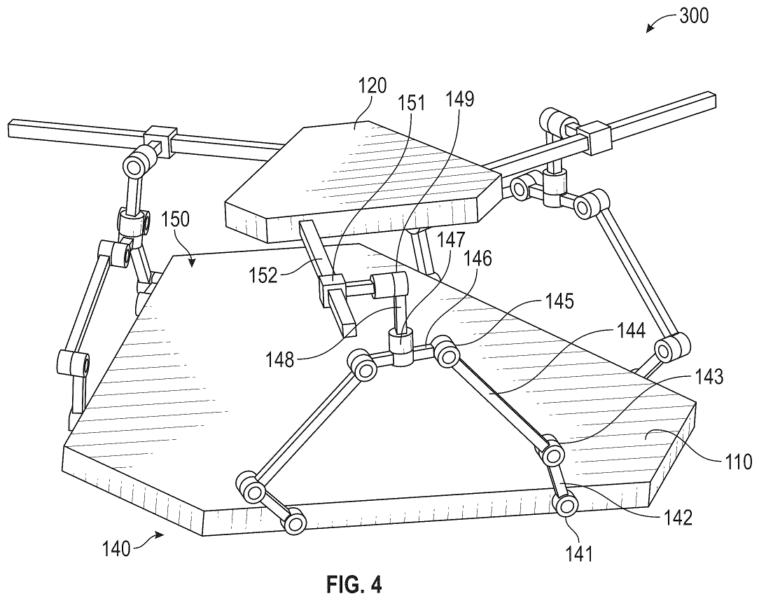

FIG. 4 is a perspective view of a motion simulation system 300 in accordance with some embodiments. With reference to FIG. 4, the motion simulation system 300 includes features that are similar to the features of motion simulation system 100. In some embodiments, the motion simulation system 300 does not include weight supporting links and instead utilizes the positioning links 140 to position the platform 120 in a desired manner and also support the weight of the platform 120 and any payload thereon.

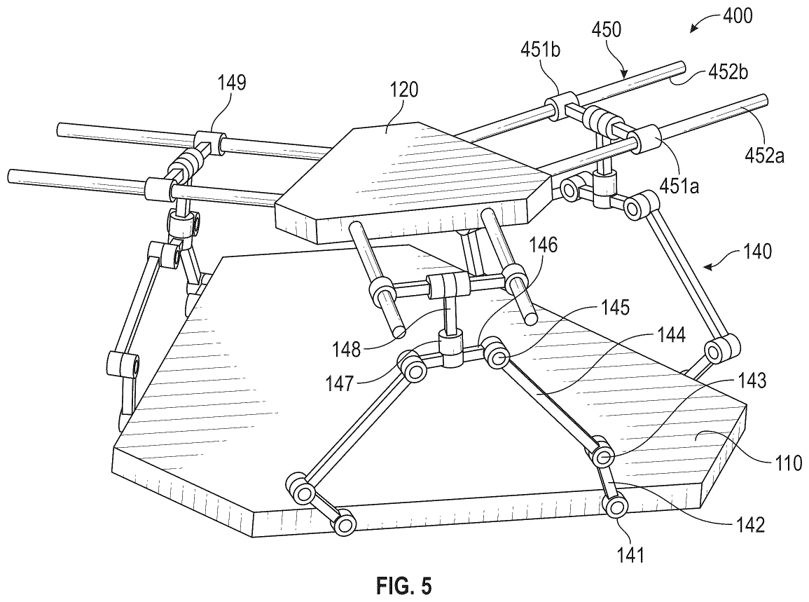

FIG. 5 is a perspective view of a motion simulation system 400 in accordance with some embodiments. With reference to FIG. 5, the motion simulation system 400 includes features that are similar to the features of motion simulation system 100. In some embodiments, the motion simulation system 400 can include multiple sliding assemblies 450 to allow the platform 120 to slide or translate relative to other positioning links 140. As illustrated, the motion simulation system 400 can include multiple sliding positioning links 452a, 452b coupled to the platform 120. In some embodiments, the motion simulation system 400 includes corresponding sliding joints 451a, 451b that allows the sliding positioning links 452a,452b slide, translate, or otherwise move relative to the joint 149 and other positioning links 140, permitting the platform 120 to slide, translate, or otherwise move relative to the link 150 and other positioning links 140. In some embodiments, the sliding joints 451a, 451b can be prismatic joints, cylindrical joints, or any other suitable type of joints.

In some embodiments, the positioning or configuration of elements of the motion simulation system can be varied or modified while being consistent with the kinematic form of the motion simulation systems described herein. In some embodiments, additional and/or redundant elements can be introduced to physically implement mechanisms described herein without altering the underlying kinematic concepts described here. In some embodiments, various actuators, including direct or indirect drive rotary actuators, direct or indirect drive linear actuators, geared actuators, or any other suitable actuators can be utilized.

During operation, the motion simulation systems described herein can utilize the positioning links and/or actuators to place the platform and the payload in a desired pose or a streamed succession of poses in response to position input by rotating and/or translating the positioning links of the motion simulation system. In the depicted example, a controller of the motion simulation system can receive a position input as a streamed succession of pose vectors.

During a pre-processing stage, each received pose vector can be transformed or scaled. Further, each received pose vector can be processed with respect to a kinematic state of the system (e.g. to limit the maximum acceleration and/or velocity of the motion simulation system). Further, each received pose vector can be validated against the kinematic constraints, physical mechanical limits, or motion envelope of the motion simulation system.

In the depicted example, a valid pose vector is then translated into a position vector for each respective positioning link or actuator, which is commanded to the respective positioning actuator. In some embodiments, the controller of the motion simulation system utilizes inverse kinematics to control the position of the platform.

For example, the controller processes the pose vector to provide an effector position vector, which may be the desired position or orientation of the positioning links or actuators in the kinematic chains connecting the base to the platform. Therefore, a pre-described succession of input pose vectors can result in highly controlled motion of the platform. In some embodiments, the motion control system can control operation of the positioning links and any corresponding actuators to provide six degrees of freedom.

In some embodiments, while a controller of the motion simulation system may collectively or cooperatively provide each positioning actuator an effector position vector to provide a desired platform pose, the motion control simulation system may have independent closed loop control of each positioning actuator. For example, in some embodiments, the motion simulation system may use position information or other operational information of the positioning actuator to provide closed-loop feedback, adjustment, or control of the input signal to the positioning actuator to provide a desired position or pose.

It will also be understood that, although the terms first, second, etc. are, in some instances, used herein to describe various elements, these elements should not be limited by these terms. These terms are only used to distinguish one element from another. For example, a first valve could be termed a second valve, and, similarly, a second valve could be termed a first valve, without departing from the scope of the various described embodiments. The first valve and the second valve are both valves, but they are not the same valve unless explicitly stated.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A movable platform system, comprising:
a base;
a platform; and
a plurality of links coupling the base to the platform and configured to permit the platform to move in six degrees of freedom relative to the base, wherein the plurality of links comprises:
a first link coupled to the base;
a second link coupled to the first link via a first rotational joint;
a third link coupled to the second link; and
a fourth link, wherein the fourth link is coupled to the third link via a second rotational joint and coupled to the platform via a prismatic joint.

2. The movable platform system of claim 1, wherein the first link is coupled to the base via a third rotational joint.

3. The movable platform system of claim 1, wherein the first link and the second link rotate in parallel or coinciding planes.

4. The movable platform system of claim 1, wherein the third link rotates in a perpendicular plane relative to the second link.

5. The movable platform system of claim 1, wherein the fourth link rotates in a perpendicular plane relative to the third link.

6. The movable platform system of claim 1, further comprising a second plurality of links coupling the base to the platform and configured to permit the platform to move in six degrees of freedom relative to the base.

7. The movable platform system of claim 1, wherein the first rotational joint comprises a rolling bearing.

8. The movable platform system of claim 1, wherein the plurality of links comprises a weight bearing link coupled to the base and the third link.

9. The movable platform system of claim 8, wherein the weight bearing link, the first link, and the second link move in parallel or coinciding planes.

10. The movable platform system of claim 8, wherein the weight bearing link comprises a weight bearing actuator.

11. The movable platform system of claim 1, wherein the first link comprises a positioning actuator.

12. The movable platform system of claim 11, further comprising a controller configured to control operation of the positioning actuator.

13. A motion simulation system, comprising:
a base;
a platform;
a positioning actuator coupled to the base, wherein the positioning actuator is configured to position the platform relative to the base; and
a plurality of links coupling the base to the platform and configured to permit the platform to move in six degrees of freedom relative to the base, wherein the plurality of links comprises:
a first link coupled to the positioning actuator via a first rotational joint;
a second link coupled to the first link; and
a third link, wherein the third link is coupled to the second link via a second rotational joint and coupled to the platform via a prismatic joint.

14. The motion simulation system of claim 13, wherein the positioning actuator comprises a stator coupled to the base and a rotor coupled to the first link via the first rotational joint.

15. The motion simulation system of claim 14, wherein the first link and the rotor of the positioning actuator rotate in parallel or coinciding planes.

16. The motion simulation system of claim 13, wherein the second link rotates in a perpendicular plane relative to the first link.

17. The motion simulation system of claim 13, wherein the third link rotates in a perpendicular plane relative to the second link.

18. The motion simulation system of claim 13, further comprising a second positioning actuator and a second plurality of links coupling the base to the platform and configured to permit the platform to move in six degrees of freedom relative to the base.

19. The motion simulation system of claim 13, wherein the first rotational joint comprises a rolling bearing.

20. The motion simulation system of claim 13, wherein the plurality of links comprises a weight bearing link coupled to the base and the second link.

21. The motion simulation system of claim 20, wherein the weight bearing link, a rotor of the positioning actuator, and the first link move in parallel or coinciding planes.

22. The motion simulation system of claim 20, wherein the weight bearing link comprises a weight bearing actuator.

23. The motion simulation system of claim 22, further comprising a controller configured to control operation of the positioning actuator and the weight bearing actuator.

24. A motion simulation system, comprising:
a base;
a platform;
a weight bearing actuator coupled to the base and the platform, wherein the weight bearing actuator is configured to support the platform relative to the base; and
a plurality of links coupling the base to the platform and configured to permit the platform to move in six degrees of freedom relative to the base, wherein the plurality of links comprises:
a first link coupled to the base; and
a second link coupled to the first link via a first rotational joint, wherein the weight bearing actuator, first link and the second link move in parallel or coinciding planes.

25. The motion simulation system of claim 24, wherein the weight bearing actuator comprises:
a pneumatic cylinder coupled to the base and defining a cavity; and
a piston rod coupled to the platform and disposed at least partially within the cavity of the pneumatic cylinder, wherein a first end of the piston rod and the cavity of the pneumatic cylinder define a volume of the pneumatic cylinder, and the volume of the pneumatic cylinder is configured to be pressurized to support a weight of the platform.

26. The motion simulation system of claim 24, further comprising a second weight bearing actuator and a second plurality of links coupling the base to the platform and configured to permit the platform to move in six degrees of freedom relative to the base.

27. The motion simulation system of claim 24, wherein the first rotational joint comprises a rolling bearing.

28. The motion simulation system of claim 24, further comprising a controller configured to control operation of the weight bearing actuator.

29. The motion simulation system of claim 24, wherein the first link comprises a positioning actuator.

30. The motion simulation system of claim 29, further comprising a controller configured to control operation of the positioning actuator and the weight bearing actuator.
